(19) United States
(12) Patent Application Publication
(10) Pub. No.: US 2024/0005395 A1
(43) Pub. Date: Jan. 4, 2024

(54) APPARATUS, METHOD AND NON-TRANSITORY COMPUTER READABLE STORAGE FOR TRANSFERRING A PREDICTED PORTION OF A FUTURE POSITION OF USER DATA

(71) Applicant: AMERICAN EXPRESS KABBAGE INC., Atlanta, GA (US)

(72) Inventor: Pinar Donmez, Atlanta, GA (US)

(21) Appl. No.: 18/219,608

(22) Filed: Jul. 7, 2023

Related U.S. Application Data
(63) Continuation of application No. 14/975,843, filed on Dec. 20, 2015, now abandoned.

(51) Int. Cl. G06Q 40/02; G06Q 40/03

(52) U.S. Cl. CPC G06Q 40/02; G06Q 40/03

(57) ABSTRACT

An example operation may include one or more of determining, via a first server, that an action is to be performed on first data associated with a user, wherein the first data is errant data, accessing a stored value related to second data associated with the user at a second server via the first server, retrieving additional data from the second data, dynamically generating a plurality of different models for predicting a future position of the user data based on the additional data, executing the plurality of different models to generate a plurality of solutions to a predefined operation, selecting a model from among the plurality of different models based on the plurality of solutions generated by the executed plurality of different models, predicting a portion of the future position of the user data accessed from the second server to transfer at a future date via execution of the selected model using the retrieved additional data and transferring the predicted portion of the future position of the user data from the stored value to the second user data on the future date.

### BACKGROUND OF THE INVENTION

### Field of the Invention

The present general inventive concept is directed to a method, apparatus, and computer readable storage medium directed to implementing a model that predicts a customer's future average daily balance.

### Description of the Related Art

Banks (and other lenders) commonly deal with delinquent accounts who are past due on the credit accounts/lines. A bank can continuously withdraw all money in the delinquent account until the account is paid up, but this would have consequences of overdrawing the account, leaving the account holder with no money, etc.

What is needed is an improved way to determine a payment amount to automatically take from a payment due account.

### SUMMARY OF THE INVENTION

It is an aspect of the present invention to provide an improved method, apparatus, and computer readable storage to determine variable payment amounts.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of determining how much of a credit line to offer a user, according to an embodiment;

FIG. 2 is a plurality of exemplary graphs using different average daily balance periods, according to an embodiment;

FIG. 3 is a pair of exemplary graphs showing average daily balance and the forecasted data, according to an embodiment;

FIG. 4 is a pair of exemplary graphs showing average daily balance, a one month forecast, and the average projected ADB, according to an embodiment;

FIG. 5 is an exemplary graph showing projected data for a different number of iterations, according to an embodiment;

FIG. 6 are further exemplary graphs illustrating downward trending and upward trending, according to an embodiment;

FIG. 7 is a flowchart illustrating an exemplary method of determining a credit line, according to an embodiment;

FIG. 8 is a block diagram illustrating hardware that can be used to implement a computer/device which can implement any and all of the methods described herein; and

FIG. 9 is a block diagram illustrating participants of the system, according to an embodiment.

FIG. 10 is a flowchart illustrating an exemplary method of determining a predicted payment, according to an embodiment; and

FIG. 11 is a flowchart illustrating an exemplary method of initiating predicted payments for delinquent accounts, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to determine a variable payment amount. A predictive model is used to predict future bank balances for a customer. Historical bank balances for the customer are available such that the system has access to the customer's daily bank balance for the customer's bank history (e.g., all of the customer's history or past two years, etc.) Mathematical models are applied to the historical balances so that a prediction can be made what that customer's balance will be at a predetermined time in the future (e.g., 4 days ahead or any other number of days (e.g., any number from 1 to 100 days or more). While no model can predict this exactly, models can be used which have a reasonably good accuracy. Ideally, the system would have at least 90 days of banking history for a user to make the best predictions, but the invention is flexible enough to make use of shorter history when needed.

Improvements of predictions of a user's future bank balances is helpful to determine optimal credit lines to offer, to provide better assessment and trends of the upslope, down slope, and flat, to result in better forecasting to project business revenue, and to help mitigate risk for a lending institution.

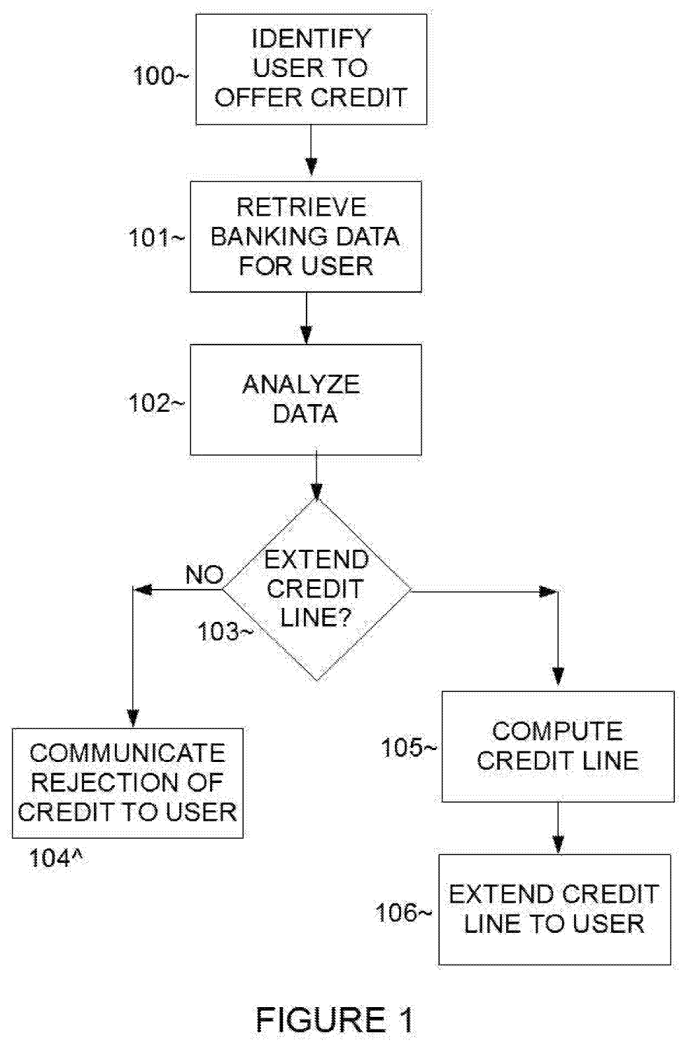

FIG. 1 is a flowchart illustrating an exemplary method of determining how much of a credit line to offer a user, according to an embodiment.

In operation 100, a user is identified to determine whether he/she will be offered a credit line (or an increased credit line). The user can be identified in numerous ways. They can apply for credit with a credit line server. The credit line server is a server which hosts a web site and application which can automatically perform all of the methods described herein. Users can also be identified as members of the credit line server (e.g., they have an account) and users can be periodically reviewed for credit line offers (or increases). While “user” is used herein, this can also refer to a company, individual person, customer, or any other entity.

From operation 100, the method proceeds to operation 101, which retrieves the user's banking data from a bank used by the user. The bank should be the user's main business bank account and the data retrieved should be balance date for each day for a historical period (e.g., past 180 days or any other such period). If the user has a number of different bank accounts, then the banking data for all of these accounts can be retrieved and added together.

From operation 101, the method proceeds to operation 102 which analyzes the banking data retrieved in operation 101. This can be done as described herein.

From operation 102, the method proceeds to operation 103, which determines, based on the analysis in operation 102, whether to extend the user a credit line. If not, then the method proceeds to operation 104, which communicates (e.g., by a pop up window, text message, email message, etc.) that the user is not yet qualified for credit (and no credit offer is made).

If in operation 103, it is determined to extend the user a credit line, then the method proceeds to operation 105, which computes the amount of the credit line to be offered to the user. This computation is described herein.

From operation 105, the method proceeds to operation 106, which extends the credit line (with the amount computed in operation 105) to the user. The credit line can be offered in the form of a credit card, a financial account (such as a bank account) to which the user can transfer cash (taken from the credit line) as the user wishes, a payment account which can be used to make electronic payments to other parties using the credit line, and any other paradigm where a financial institution extends monetary credit to a qualifying user.

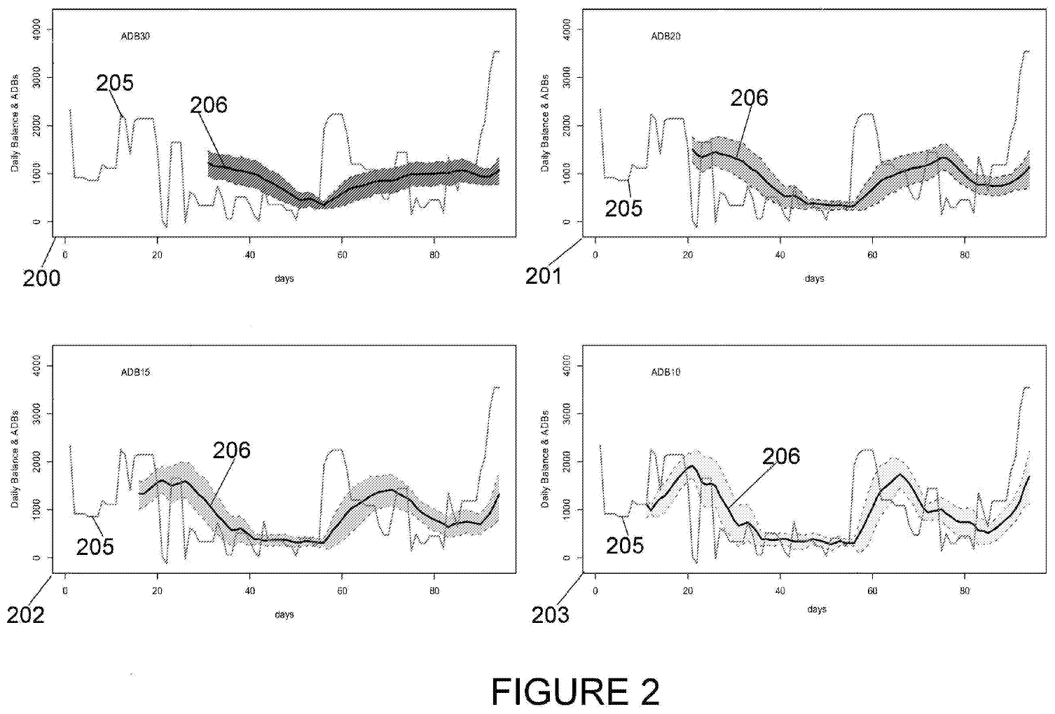

FIG. 2 is a plurality of exemplary graphs using different average daily balance periods, according to an embodiment.

A first graph 200 shows a graph of data and an ADB30 graph plotted in the same graph (shown as a black line with a grey border). ADBX is computed for each day by averaging the bank balance for the previous X days. A second graph 201 shows the same graph of data and an ADB20 graph. A third graph 202 shows the same graph of data with an ADB15 graph therein. A fourth graph 203 shows the same graph of data with an ADB10 graph therein.

The lighter line 205 in each graph represents the actual banking data, and the darker line 206 in each graph represents the average daily balance. The shaded area around each darker line 206 represents the standard deviation of the dark line 206.

Once the ADB10 graph is computed, then the next operation is to fit a model to time series of ADB10 to predict the customer's future balances. As used herein, “average

$$\text{?}$$

$$\text{?} \text{indicates text missing or illegible when filed}$$

daily balance” refers to ADB10 (although other periods of time can be used). An Autoregressive Integrated Moving Average (Arima) model is used. These models try to fit the time series data by trying to solve the following equation:

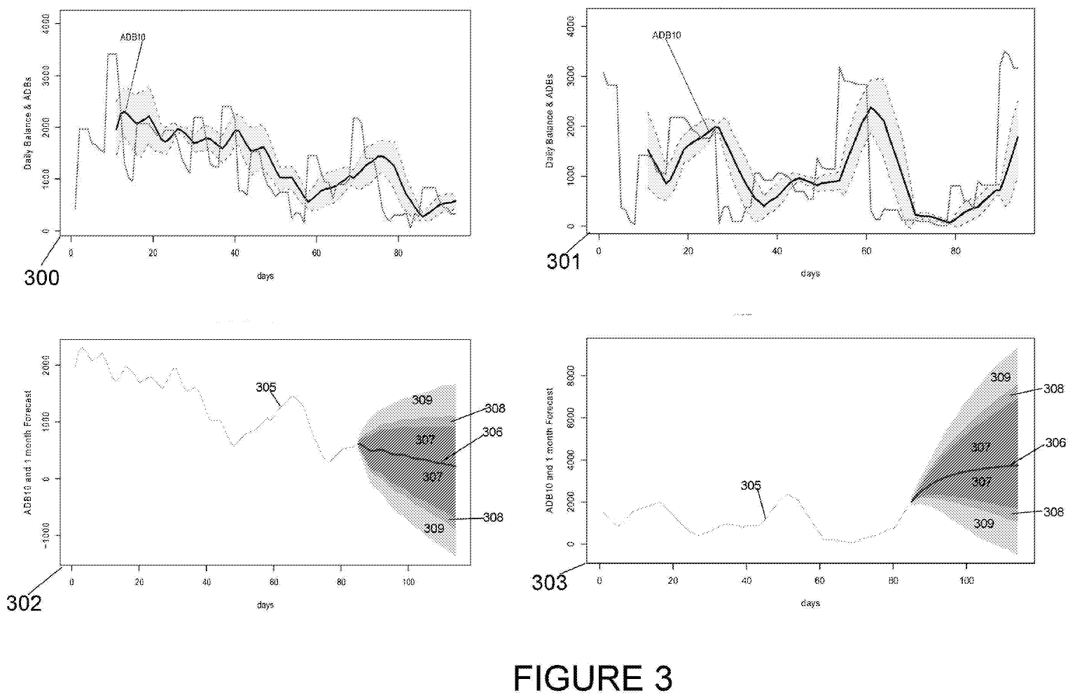

FIG. 3 is a pair of exemplary graphs showing average daily balance and the forecasted data, according to an embodiment.

A first ADB10 graph 300 and a second ADB10 graph 301 are shown. A first one month forecast graph 302 is shown for the first ADB10 graph 300. A second one month forecast graph 303 is shown for the second ADB10 graph 301.

ADB10 305 in graph 302 and 303 is the average daily balance (over 10 days) for the bank balances in graphs 300 and 301, respectively. Note that projected ADB10 306 is the predicted average daily balance (over IO days) using the forecasting methods described herein. The shaded areas represent confidence intervals (also known as confidence bounds). Shaded area I 307 represents a 70% confidence interval, shaded area 2 308 (which also includes shaded area I 307) represents an 80% confidence interval, and shaded area 3 309 (which also includes shaded area I 307 and shaded area 2 308) represents a 95% confidence interval. In other words, according to the statistical methods used herein, the upper and lower borders of the 70% confidence interval should define with 70% probability the actual average daily balance over the projected period (in the future). The 80% confidence upper and lower borders should capture the actual average daily balance over the projected period with 80% probability, and the 95% confidence interval should capture the actual average daily balance with 95% probability. Note that while 70%, 80%, and 95% confidence intervals are used herein, it can be appreciated that other percentages can be used and these are just examples of one configuration.

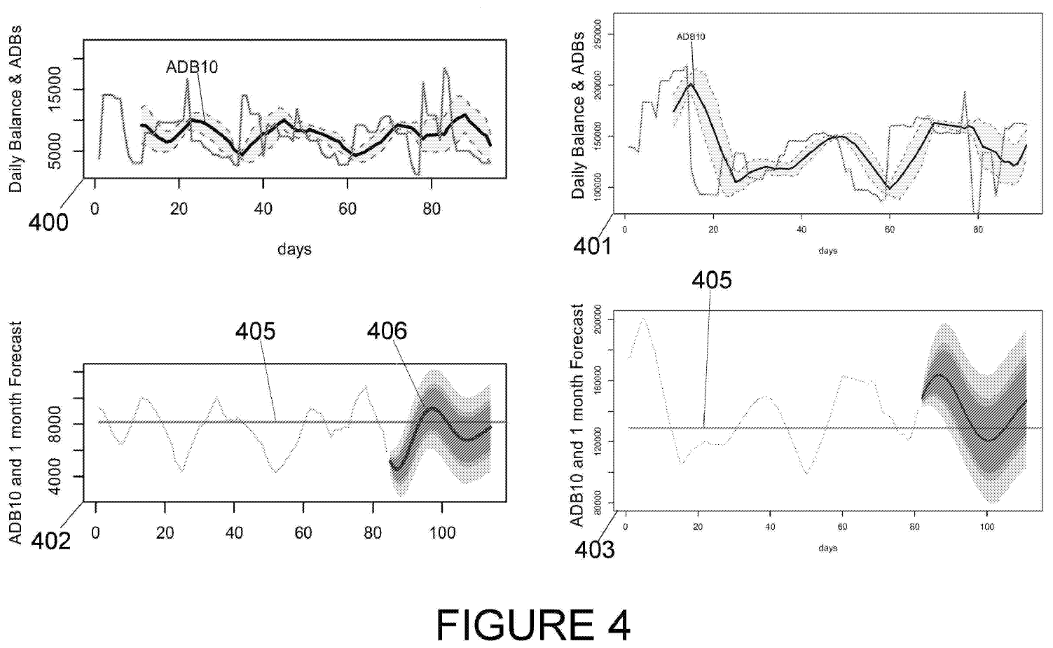

FIG. 4 is a pair of exemplary graphs showing average daily balance, a one month forecast, and the average projected ADB, according to an embodiment.

First data graph 400 shows (like the other graphs) a particular daily balance over time and the ADBIO (average daily balance computed over a period of 10 days). Second data graph 40 I is the same type of graph but just has different data. First forecast graph 402 shows the ADBIO from the first data graph 400, a projected ADBIO 406 (over one month) and an average projected ADBIO 405 for the projected one month period.

Note the difference between the projected ADBIO 406 and the average projected ADBIO 405. The former varies over time and is a forecasted (or projected or predicted) graph intended to predict this particular user's (or business's) actual average daily bank balance over 10 days for each day. The projected ADB10 406 is an attempt to “continue” the ADB10 graph which uses the actual known data. The average projected ADB10 405 is an average of the projected ADB10 406 and thus is a static quantity.

The average projected ADB10 405 is calculated as the center of a respective 70% confidence region (see FIG. 3, 307). There is an upper confidence region above the projected ADB10 406 curve (and below the top of the 70% confidence interval) and a lower confidence region below the one month projected ADB10 406 curve (and above the bottom of the 70% confidence interval). If the trend of projected ADB10 406 is upward then the upper 70% confidence region is used to compute the average projected ADB10 405, while if the trend of the one month projected ADB10 406 is downward then the lower 70% confidence region is used to compute the average projected ADB10 405. For the projected part of the graph, we calculate the difference of every consecutive pair of points (e.g., delta=projected ADB10 at time (t+1)−projected ADB10 at time t) and then take their average. If the average is positive, then the trend is upward; otherwise downward. Second forecast graph 403 shows the same types of plots but for the data in second data graph 401.

The average projected ADB10 405 is important because this is one important result of the method. The average projected ADB10 405 is a prediction of what the particular user's average daily balance will be for the projected period (e.g., 30 days). This is what the determination of how much credit to extend the particular person can be based upon. For example, the average projected ADB10 405 can be multiplied by a constant (e.g., 3). So for example, if the average projected ADB10 is $1,000, then the credit line extended to this person would be $3,000.

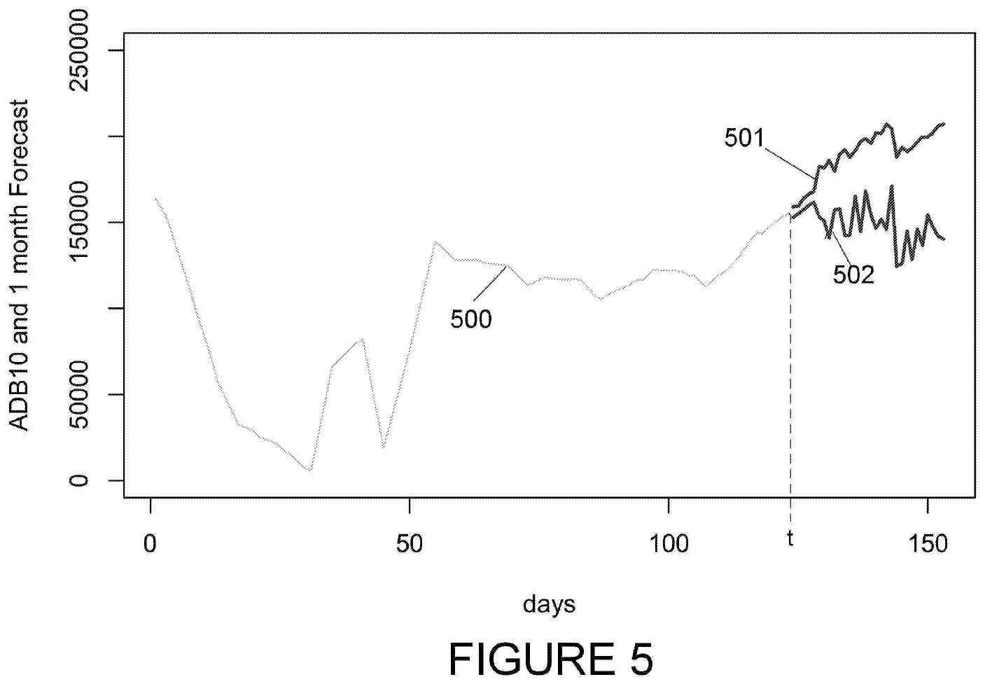

FIG. 5 is an exemplary graph showing forecasted data for a different number of iterations, according to an embodiment.

An ADB10 500 is shown. Time tin the graph can represent a day such as the current day (thus everything to the left oft is historical data and everything to the right of tare forecasts/projections). Shown is a 30 day projection. A first projected ADB 502 is shown which is based on 15 iterations (operations 702-703) and a second projected ADB 501 is shown which is based on 45 iterations (operations 702-703). Operation 704 comes after the model converges to the optimal. The second forecast 501 should theoretically be more accurate than the first forecast 502 since it is based on more iterations of the algorithm. Note that the projections are not identical because as stated herein, Et are the error terms sampled randomly from a normal distribution with zero mean which gives each graph an element of randomness.

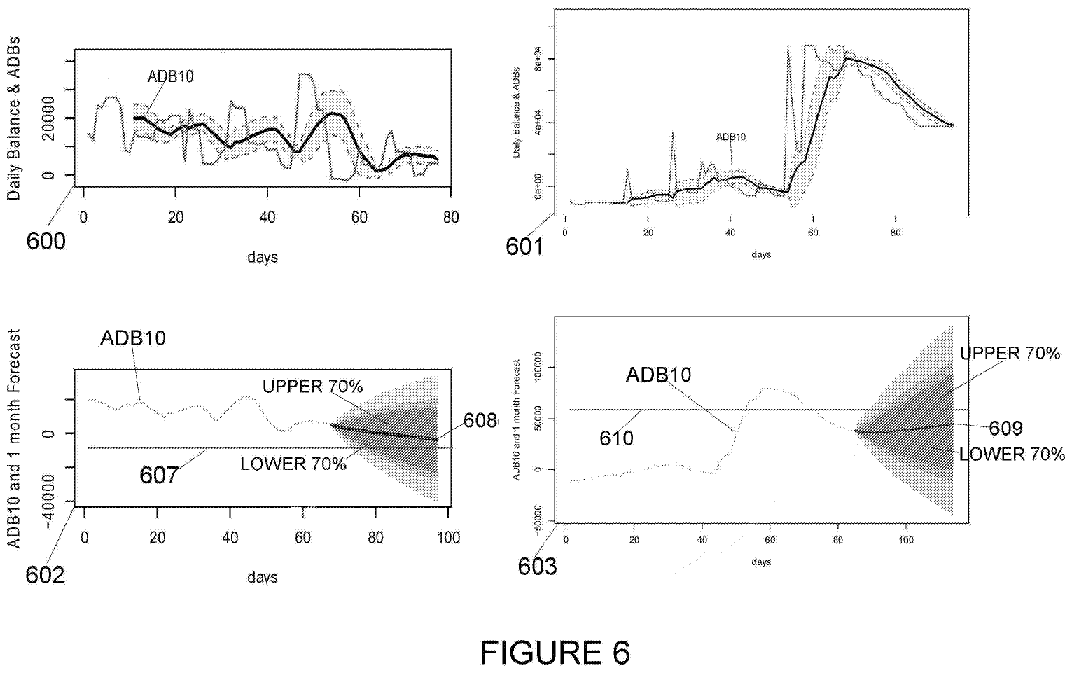

FIG. 6 are further exemplary graphs illustrating downward trending and upward trending, according to an embodiment.

Graphs 600, 601 show a person's daily balance and the respective ADB10 (like the other graphs). Graph 602 shows the same ADB10 from graph 600 as well as a projected ADB 608 for 30 days and the average projected ADB 607 for the 30 day projected period, note that the projected ADB 608 has a downward slope (trend). Graph 603 shows the same ADB10 from graph 601 as well as a projected ADB 609 for 30 days and the average projected ADB 610 for the 30 day projected period. Note that the projected average daily balance 609 has an upward slope (trend).

When the trend of the projected ADB 608 is downward (such as in graph 602), then the average projected ADB 607 is computed as the average of all of the values in between the projected ADB 608 and the lower 70% confidence interval. In other words, the average projected ADB 607 is the center of mass calculation of the lower region (between the projected ADB 608 and the lower 70% confidence interval). When the trend of the projected ADB 609 is upward (such as in graph 603), then the average projected ADB 610 is computed as the average of all of the values in between the projected ADB 609 and the upper 70% confidence interval. In other words, the average projected ADB 610 is computed by using a center of mass calculation for the upper confidence region (between the projected ADB 609 and the upper 70% confidence interval). Note the difference between the projected ADB 608 and the average projected ADB 607. The projected ADB 608 is a graph which varies overtime and is a prediction of the ADB of the user for each day in the future, while the average projected ADB 607 is a predicted static amount (average) of the user's average daily balance over the projection (predicted, forecasted) period (e.g., 30 days in the future). Center of mass calculation is the average of all the values in the corresponding confidence region. If the projected forecast is flat (has no slope) or its slope is very small (below a certain threshold) then the user (candidate for a credit line) should be denied credit. If a computed average projected ADB is negative, then the user should also be denied an offer of credit.

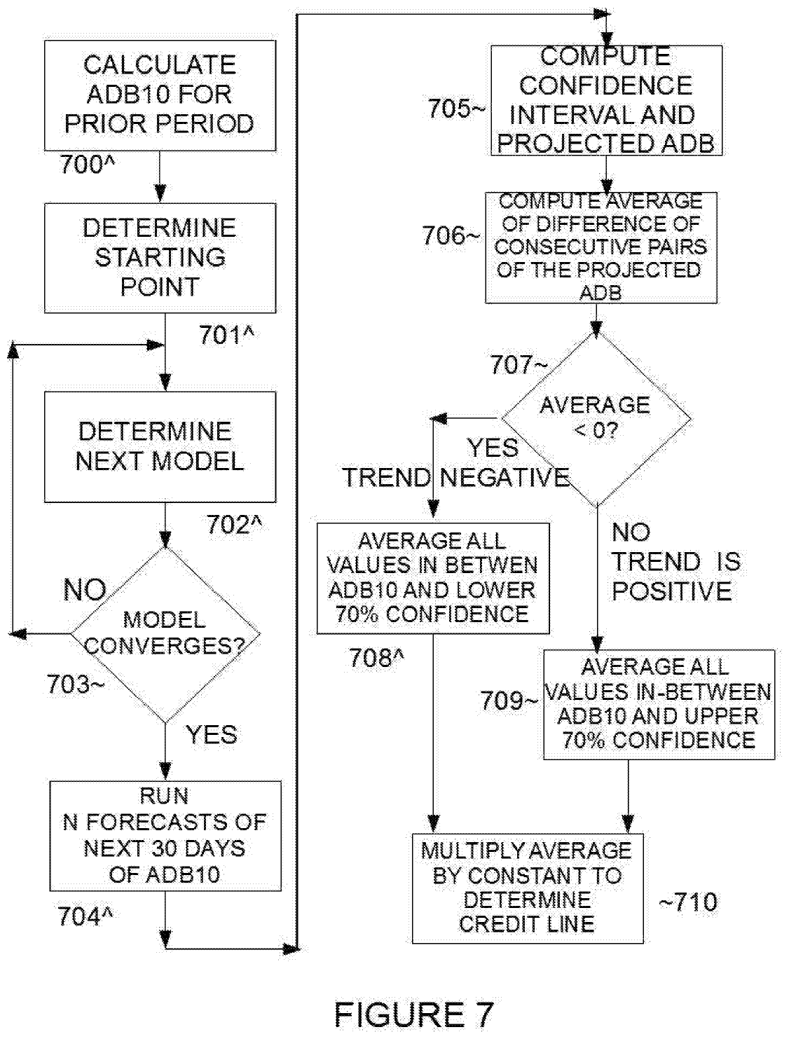

FIG. 7 is a flowchart illustrating an exemplary method of determining a credit line, according to an embodiment.

In operation 700, the 10 day average daily balance (ADB10) is computed for a predetermined period of time before the current day (e.g., 3 months, etc.). The 10 day average daily balance (ADB10) is, for a given day in the predetermined period of time, the average of the closing balance (instead of closing balance, opening balance or average day's balance can be used) for the prior ten days. Thus to compute the ADB10 for period of 90 days before the current day, it would be necessary to the customer's banking data for 100 days prior to the current day. The first day the customer's ADB10 could be computed would be 10 days after the first day of the period. Other periods for average daily balance can be used besides ten days, although ten days (ADB10) is preferred.

The next step is to fit a model to the time series of ADB10 to predict the future. The method adopts the idea of Autoregressive Integrated Moving Average (Arima) models. These models try to fit the time series data by trying to solve the following equation (1):

$$\text{?}$$

$$\text{?} \text{indicates text missing or illegible when filed}$$

where {X1, X2 . . . } are the ADB10 at day t in our case, and Et are the error terms sampled randomly from a normal distribution with zero mean. p, q, a, 8 are all parameters of the model. p and q are non-negative integers and fitting this model to the data is equivalent of finding their optimal values. The search space is too large to try all possible values for the parameters. Instead, a greedy approach is followed.

In operation 701 we determine a starting point. Start with the smallest possible combinations of values; namely {{p=0. q=0}, {p=2, q=2}, {p=1, q=0}, {p=0, q=1}}. Solve equation 1 for each of these four combinations of values. The best model is selected as the one with the smallest AIC (Akaike Information Criterion). AIC is a well-known measure in statistics that measure the relative quality of a statistical model. The quality is measured by the goodness of the fit of the model (negative likelihood) and the model complexity. Hence, models with lower AIC is better since they provide better trade-off between model complexity and accuracy. The best model chosen in this initial step is treated as the current model before going into the next step.

Once the starting point has been determined, then the method can proceed to operation 702 which determines the next model. p and q are varied from the current model by +1 and −1. In other words, eight new variations are tried: (p, q+1), (p+1, q), (p, q−1), (p−1, q), (p+1, q+1), (p−1, q−1), (p+1, q−1), and (p−1, q+1). The AIC of each of the eight variations is computed and the one with the smallest AIC now becomes the current model.

From operation 702, the method proceeds to operation 703 which determines whether there is convergence. There is convergence when no variation (out of the eight variations in the preceding paragraph) has a lower AIC than that of the current model (or the difference is below a predetermined small threshold). If there is no convergence then the method repeats operation 702 again.

Once there is convergence in operation 703, then the method proceeds to operation 704 which runs N forecasts (projections) of the next 30 days (month) of ADB10. Note that while a 30 day forecast period is determined herein, the forecast period does not necessarily have to be 30 days and any other period can be used as well (e.g., 20 days, 45 days, etc.) The more days from the current day that is being forecasted, the less accurate the forecast will likely be.

Once the parameters of the model are estimated by the iterative process above, they are plugged into the following equation (2) to forecast the next 30 days of ADBIO:

$$\text{?}$$

$$\text{?} \text{indicates text missing or illegible when filed}$$

Initially, n is the first day for which ADB10 is not available and thus the known p prior values are substituted into Equation 2. Next, use n to refer to second day for which the data is not available, but use the forecasted value from the previous day in the right hand side of the equation. Repeat the same procedure for 30 days to forecast the next 30 days' worth of ADBIO. Note that after p days, all right-hand side values in the equation become predicted values from prior steps.

The forecasting operation should be run at least 1,000 (N) times. Then the method can proceed to operation 705, which computes the projected ADB (e.g., 608, 609) and confidence intervals for the forecast period. In addition, the projected ADB (which varies over time) is determined by taking the average of all of the N runs (from operation 704). The upper and lower confidence interval is computed which correspond to the 70^{th} percentile (70% confidence interval) of the simulated N runs. Note that the confidence interval is not necessarily vertically symmetrical, in that it can be higher (or lower) over the average then below the average. In addition to 70%, of course other percentiles can be used as well.

From operation 705, the method proceeds to operation 706, which computes the difference of each consecutive pair of the projected ADB (determined in operation 705) and then takes the average of these differences. The average of these differences is used to determine the trend.

From operation 706, the method proceeds to operation 707, which determines whether the trend is negative or positive. If the average of the differences of each consecutive pair of the projected ADB (computed in operation 706) is less than 0, then the trend is flagged as negative otherwise the trend is flagged as positive.

If in operation 707, the trend is flagged as negative (average of the differences of consecutive pairs of the projected ADB is less than zero), then the method proceeds to operation 708, which computes the average projected ADB (e.g., 607) of all of the values in between the projected ADB and the lower 70% confidence interval (also referred to as confidence bound).

If in operation 707 the trend is flagged as positive (average of the differences of consecutive pairs of the projected ADB is not less than zero), then the method proceeds to operation 709, which computes the average projected ADB (e.g., 610) of all of the values in between the projected ADB and the upper 70% confidence interval (confidence bound).

Note that in FIG. 6, graph 602 shows a downward trend and the average projected ADB 607 for the 30 day projected period is computed as the center of the lower 70% confidence region (the lower confidence region being between the projected ADB 608 and the lower 70% confidence bound). Note that in FIG. 6, graph 603 shows an upward trend and the average projected ADB 610 for the 30 day projected period is computed as the center of the upper 70% confidence region (the upper confidence region being between the projected ADB 609 and the upper 70% confidence bound).

From operations 708, 709, the method proceeds to operation 710, which multiplies the average projected ADB (determined in either operation 708 or 709) by a constant in order to determine the credit line for the given user. The constant can be any number (e.g., 2 to 10) such as three. So if the average projected ADB is $2,000 and the constant used is three, then the amount of credit line to offer this particular user would be $6,000. This can be communicated to the user (via a web interface, instant message, email, etc.) and the credit can then actually be extended to the user.

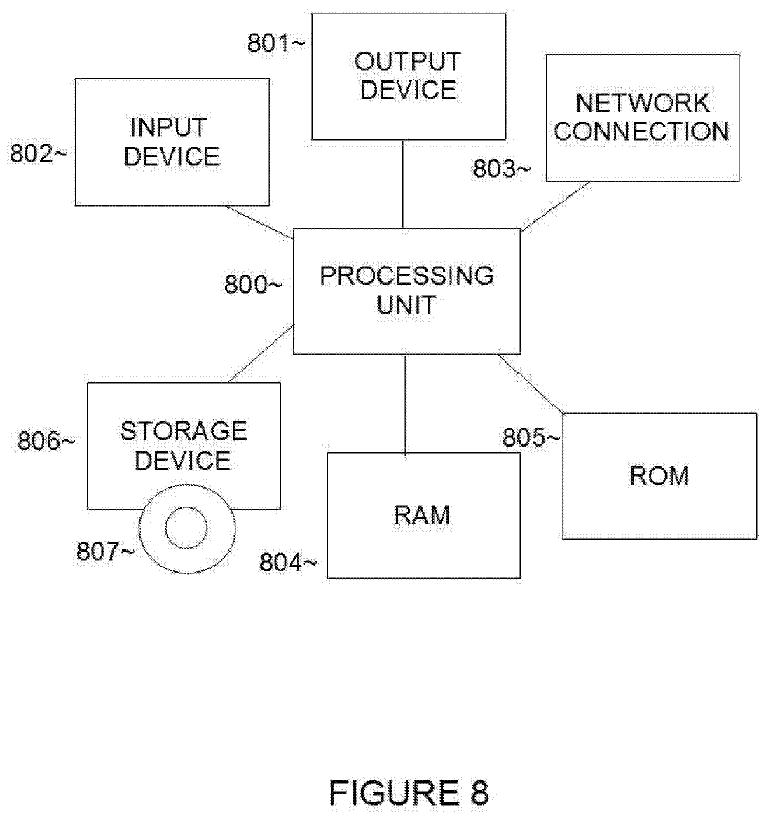

FIG. 8 is a block diagram illustrating hardware that can be used to implement a computer/device which can implement any and all of the methods described herein. The computer can be the platform, servers, personal computers, cell phones, or any electronic device used as part of the system. Any and all of the methods described herein can be installed as software on the device.

A processing unit 800 (such as a microprocessor and any associated components) is connected to an output device 801 (such as an LCD monitor, touch screen, CRT, etc.) which is used to display to the user any aspect of the method (including any values described herein), and an input device 802 (e.g., buttons, a touch screen, a keyboard, mouse, etc.) which can be used to input from the user any input needed by any feature described herein. All methods and features described herein can be performed by the processing unit 800 by loading and executing respective instructions. The processing unit 800 can also be connected to a network connection 803, which can connect to a computer communications network such as the Internet, a LAN, WAN, etc. The processing unit 800 is also connected to a RAM 804 and a ROM 805. The processing unit 800 is also connected to a storage device 806 which can be a DVD-drive, CD-ROM, flash memory, etc. Multiple such processing units can also work in collaboration with each other (in a same or different physical location). A non-transitory computer readable storage medium 807 can store a program which can control the electronic device to perform any of the methods described herein and can be read by the storage device 806.

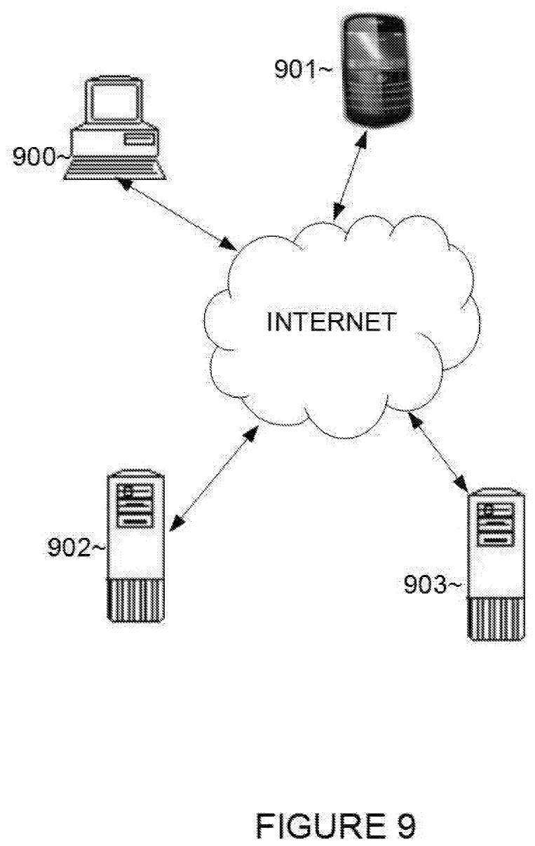

FIG. 9 is a block diagram illustrating participants of the system, according to an embodiment.

Any number of users 900, 901 (only two are shown) can connect to a credit line server 902 via the internet. Users can use a personal computer, tablet, cell phone, laptop, or any computing device. The credit line server 902 is an electronic computer (can have the structure illustrated in FIG. 8) which is configured (programmed) to perform all of the methods described herein. So in other words, the credit line server 902 will implement the methods described herein in order to determine whether to extend credit to a user or not (and actually extend the credit when approved). Thus, the credit line server 902 also can facilitate extending credit to users. The credit line server 902 also maintains all user accounts and implements all communications with users. Users can register themselves on the credit line server 902 in order to avail themselves of being considered for a credit line. A user typically would have to give authorization to the credit line server 902 to inspect the user's bank accounts, and the user can also provide his/her username and password so that the credit line server 902 can automatically log into the user's banking institution in order to retrieve the user's historical banking data (operation 101).

A banking server 903 is a server used by a bank (the user's bank) so that the credit line server 902 can communicate therewith and electronically retrieve any and all of user's banking data that is needed by the credit line server 902 in order to make the credit analysis/decision. This would include (but not limited to) daily balances for the user going back at least 90 days.

In a further embodiment, the modeling method described herein can be applied to a predicted payment system. When a creditor (bank) grants credit to its customers (accounts), it is to be expected that some accounts fall delinquent. Upon granting credit, the customer would agree electronically with the bank that the customer will make minimum payments monthly to keep the account current. It is important for the credit grantor to ensure that the delinquent accounts are brought current (the past due is paid). Agreements can be made between the customer and the bank (creditor) that if the customer falls behind in the required payments (becomes delinquent), the bank is allowed to automatically withdraw money (as much as the bank wants) from the customer's bank account until the account is brought current.

Naturally, the bank would prefer to continuously take all the money out of a delinquent customer's account until the account is current. One problem with this approach is that there is a lag (typically from one to four business days) between the time a payment is initiated out of a customer's account and when the payment is actually processed. So if a delinquent customer's account has $130.35 in it, and the account's past due amount is $150, then the bank would prefer to transfer all $130.35 from this account to the bank to pay off the account's past due amount. One problem with this, is that because of the lag, by the time the payment is actually processed the account may have less than the $130.35 in it which would cause the payment to exceed the current balance which could result in the financial institution administering the account (e.g., the account's bank) to decline the transaction. Another problem with withdrawing an amount greater than an account holder actually has is this could also cause the account to be overdrawn, incurring banking penalties to the account holder.

One solution to this issue is to predict what the balance will be after the lag period. For example, if the lag is three days, then the predictive algorithm described herein can be applied so that the balance of the customer's account in three days can be predicted. Then either this entire amount, or a percentage of this predicted amount, would be initiated to be transferred out of the customer's account. This would reduce the number of times such a payment would be declined.

Thus, for delinquent accounts, a future balance is predicted (in the short term future, such as one to four days) and then that amount or a percentage (less than 100) of that amount is automatically deducted from each respective delinquent account. Thus, the payments that are taken from the delinquent account are variable (non-predetermined) in that they are computed based on predictions for each particular account. All of the methods described for determining a credit line can also applied to determining a payment amount.

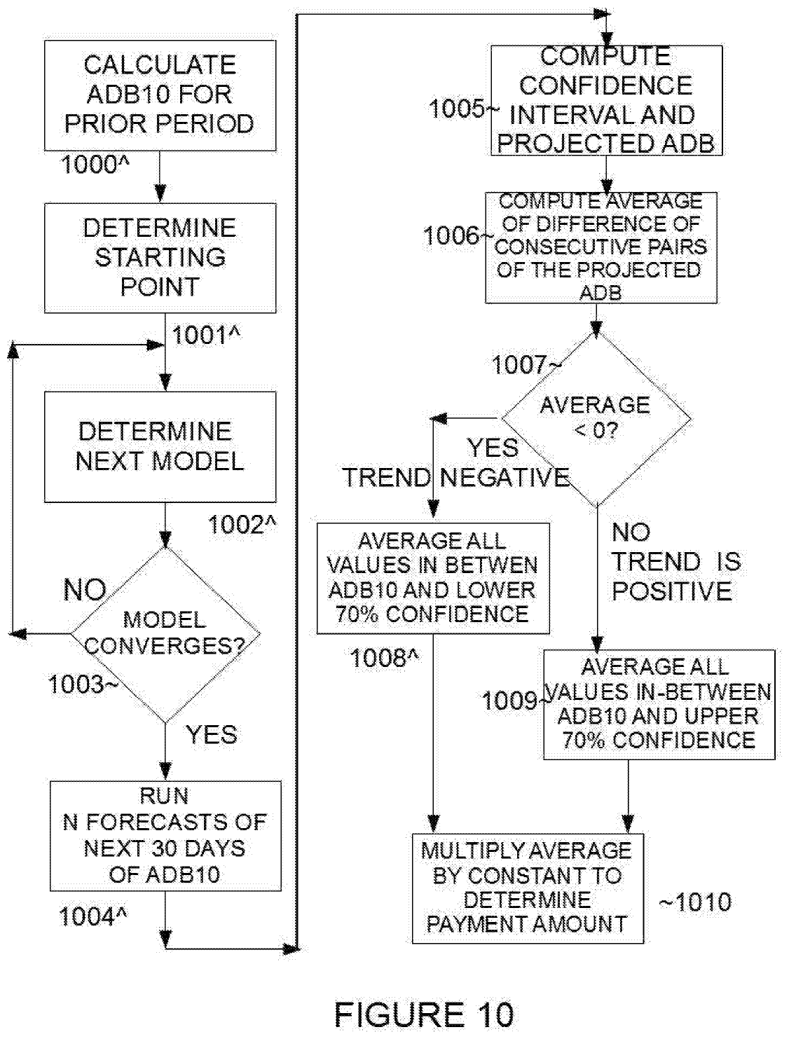

FIG. 10 is a flowchart illustrating an exemplary method of determining a predicted payment, according to an embodiment.

Note that FIG. 10 operates the same as FIG. 7 but for the last operation 1010. While operation is the same, parameters for FIG. 10 can also be optionally tweaked to optimize the algorithm for short term forecasting based on the corresponding bank's settlement period.

In operation 1010, the average received from either operation 1008 or 1009 is multiplied by a constant to determine the payment amount which will be automatically initiated to be transferred from the respective delinquent account to the bank (who offered the owner of the delinquent account credit who is now delinquent). The constant can be any number from Oto 100%, for example a constant of 75% would automatically initiate a payment to the bank of 75% of the predicted balance. This still leaves the account owner with 25% so the account owner is not completely without funds.

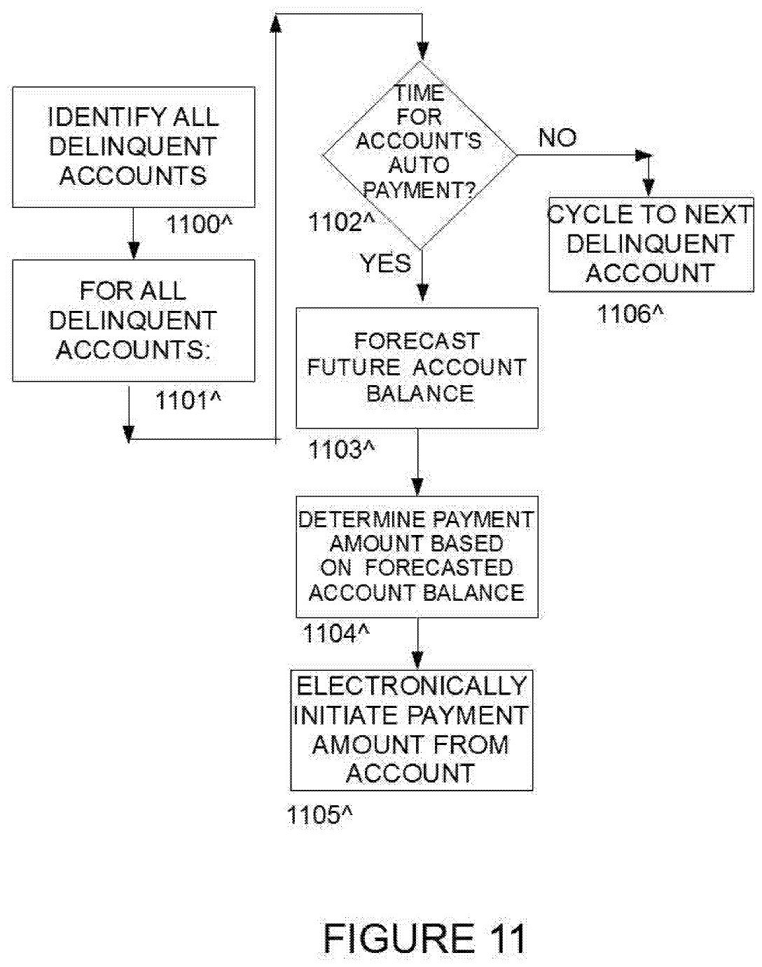

FIG. 11 is a flowchart illustrating an exemplary method of initiating predicted payments for delinquent accounts, according to an embodiment.

The method can begin with operation 1100, which identifies all delinquent accounts. This can be done using any database (e.g., a SQL database, etc.) for all delinquent accounts (accounts that have a past due amount) are identified.

From operation 1100, the method proceeds to operation 1101, which begins at operation 1102 for all delinquent accounts and operations 1102-1106 are executed for each such delinquent account.

In operation 1102, it is determined whether it is time to automatically initiate a payment from the delinquent's account. Parameters can be set as when this would happen. For example, it could happen one per month (e.g., on the last day of each month). Alternatively, delinquent accounts can be so processed more frequently, e.g., once a week each delinquent account would be reviewed and if there is enough money (e.g., the account's balance is greater than a constant such as $20 for an automatic payment) then one would be made.

If in operation 1102, it is not time to initiate a payment for this respective account (also referred to as delinquent account), then the method proceeds to operation 1106 which would cycle to the next delinquent account (e.g., processing for this particular account ends while processing would continue at operation 1102 for other accounts).

If in operation 1102, it is time to make an automatic payment for this particular account, then the method proceeds to operation 1103, forecasts a future account balance for this account. This can be done as set forth in operations 1000 to 1009 (or operations 700 to 709 which are identical but for an optional change in parameters).

Once the future account balance (e.g., three business days forward which is how long an automatic payment would take to hit the account), the method proceeds to operation 1104 determine which determines the payment amount based on the forecasted account balance. In an embodiment, if the forecasted payment amount is less than a predetermined threshold (e.g., $50) then no payment would be taken (e.g., method proceeds to operation 1106) so as to not leave the account holder broke.

The payment amount would be determined by computing a percentage of the forecasted future account balance. For example, the payment amount could be 80% of the forecasted future account balance. This, when the payment (which would be initiated in operation 1105) hits the account, it would be unlikely to be larger than the account balance by virtue of the forecast as well as taking a smaller amount (e.g., percentage less than 100%) of that forecasted balance. Of course, the predicted future balance cannot be guaranteed to be accurate and it is still possible that the predicted balance would be greater than the actual balance which can result in the payment amount being greater than the future balance. However, such occurrences should be reduced using the methods described herein.

From operation 1104, the method proceeds to operation 1105, which initiates the payment amount computed in operation 1104 from the account. This means that a request is sent to the account's financial institution (with whatever security features are required such as passwords, encryption keys, etc.) to transfer the payment amount from the account into an account held by the bank (creditor) that account holder owes. Upon the request (initiation) being completed, the actual transfer will take place after the lag period. The account holder should be notified (via email, etc.) that the automatic payment has been initiated including the amount of the automatic payment electronic paid to the bank (creditor). The payment should clear in a number of days (e.g., four days), in which the creditor's account (bank) will reflect the payment and the account itself will reflect the debit of the payment amount. This payment is also reflected in the account's banking history (as with all other transactions in the account).

While some embodiments described herein refer to addressing issues relating to delinquent accounts, all of the embodiments herein can also be applied to all kinds of accounts where there is access to historical data (bank statements and/or balances) regardless of whether they are delinquent or not. Thus, all methods described herein can be applied to any account that has a payment due (whether delinquent or not).

While one processing unit (or device/computer) is shown, it can be appreciated that one or more such processor/computer can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.) which can then be executed by one or more processing units.

All components of the system (e.g., platform, servers, computers, databases, etc.) can communicate with each other using a computer communication network (e.g., the internet) in order to exchange data as needed by the method.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a (non-transitory) computer readable storage medium to control a computer. Programs and/or data required to implement any of the methods/features described herein can all be stored (and executed therefrom to perform any of the methods/features) on any non-transitory computer readable storage medium (volatile or non-volatile, such as CD-ROM, RAM, ROM, EPROM, microprocessor cache, etc.)

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method, comprising:
determining, via a first server, that an action is to be performed on first data associated with a user, wherein the first data is errant data;
accessing a stored value related to second data associated with the user at a second server via the first server;
retrieving additional data from the second data;
dynamically generating a plurality of different models for predicting a future position of the user data based on the additional data;
executing the plurality of different models to generate a plurality of solutions to a predefined operation;
selecting a model from among the plurality of different models based on the plurality of solutions generated by the executed plurality of different models;
predicting a portion of the future position of the user data accessed from the second server to transfer at a future date via execution of the selected model using the retrieved additional data; and
transferring the predicted portion of the future position of the user data from the stored value to the second user data on the future date.

2. The method of claim 1, wherein retrieving the additional data from the second data is based on a predetermined window of time.

3. The method of claim 2, comprising executing the selected model using the retrieved additional data based on the predetermined window of time to predict the portion of the future position.

4. The method of claim 1, comprising transmitting a request to a second server with encryption keys needed to transfer the portion of the future position from the second data to the first data.

5. The method of claim 1, comprising transmitting an electronic mail to an email account of the user with a notification of the transferring of the portion of the future position.

6. The method of claim 1, comprising outputting the portion of the future position of the second data to transfer to a device of the user via one or more of an electronic mail, an instant message, and a web interface.

7. The method of claim 1, wherein predicting the portion of the future position of the user data comprises executing the selected model using at least ninety days of the retrieved additional data.

8. An apparatus, comprising:
a first server;
a second server;
memory communicatively coupled to the first server and the second server;
wherein the first server:
determines that an action is to be performed on first data associated with a user, wherein the first data is errant data;
accesses from a memory a stored value related to second data associated with the user at a second server;
retrieves additional data from the second data;
dynamically generates a plurality of different models to predict a future position of the user data based on the additional data;
executes the plurality of different models to generate a plurality of solutions to a predefined operation;
selects a model from among the plurality of different models based on the plurality of solutions generated by the executed plurality of different models;
predicts a portion of the future position of the user data accessed from the second server to transfer at a future date via execution of the selected model using the retrieved additional data; and
transfers the predicted portion of the future position of the user data from the stored value to the second user data on the future date.

9. The apparatus of claim 8, wherein retrieval of the additional data from the second data is based on a predetermined window of time.

10. The apparatus of claim 9, wherein the first server executes the selected model using the retrieved additional data based on the predetermined window of time to predict the portion of the future position.

11. The apparatus of claim 8, wherein the first server transmits a request to a second server with encryption keys needed to transfer the portion of the future position from the second data to the first data.

12. The apparatus of claim 8, wherein the first server transmits an electronic mail to an email account of the user with a notification of the transferring of the portion of the future position.

13. The apparatus of claim 8, wherein the first server outputs the portion of the future position of the second data to transfer to a device of the user via one or more of an electronic mail, an instant message, and a web interface.

14. The apparatus of claim 8, wherein prediction of the portion of the future position of the user data comprises an execution by the first server of the selected model using at least ninety days of the retrieved additional data.

15. A non-transitory computer readable storage medium comprising instructions that when read by at least one processor, cause the at least one processor to perform:
determining, via a first server, that an action is to be performed on first data associated with a user, wherein the first data is errant data;
accessing a stored value related to second data associated with the user at a second server via the first server;
retrieving additional data from the second data;
dynamically generating a plurality of different models for predicting a future position of the user data based on the additional data;
executing the plurality of different models to generate a plurality of solutions to a predefined operation;
selecting a model from among the plurality of different models based on the plurality of solutions generated by the executed plurality of different models;
predicting a portion of the future position of the user data accessed from the second server to transfer at a future date via execution of the selected model using the retrieved additional data; and
transferring the predicted portion of the future position of the user data from the stored value to the second user data on the future date.

16. The non-transitory computer readable storage medium of claim 15, wherein the instructions further cause the processor to perform retrieving the additional data from the second data is based on a predetermined window of time.

17. The non-transitory computer readable storage medium of claim 16, wherein the instructions further cause the processor to perform executing the selected model using the retrieved additional data based on the predetermined window of time to predict the portion of the future position.

18. The non-transitory computer readable storage medium of claim 15, wherein the instructions further cause the processor to perform transmitting a request to a second server with encryption keys needed to transfer the portion of the future position from the second data to the first data.

19. The non-transitory computer readable storage medium of claim 15, wherein the instructions further cause the processor to perform transmitting an electronic mail to an email account of the user with a notification of the transferring of the portion of the future position.

20. The non-transitory computer readable storage medium of claim 15, wherein the instructions further cause the processor to perform outputting the portion of the future position of the second data to transfer to a device of the user via one or more of an electronic mail, an instant message, and a web interface.
